(19) United States
(12) Patent Application Publication
(10) Pub. No.: US 2002/0139182 A1
(43) Pub. Date: Oct. 3, 2002

(54) Systems and methods for projectile recovery

(76) Inventor: Leslie P. Duke, Silver Creek, GA (US)

Correspondence Address: HINKLE & O'BRADOVICH, LLC, 395 SCENIC HIGHWAY, LAWERENCEVILLE, GA, 30045, US

(21) Appl. No.: 09/773,234

(22) Filed: Jan. 31, 2001

(51) Int. Cl. G01L 5/14

(52) U.S. Cl. 73/167

(57) ABSTRACT

A method and apparatus for trapping projectiles so that the projectiles are not damaged is disclosed. An elongated trough is typically filled with alternating layers of a foam substance and a fibrous substance. Alternatively, the trough can be filled with just a foam or fibrous substance. A projectile launcher such as a gun is connected to the trough and a projectile is shot into the filling substance substantially parallel a longitudinal axis of the trough. The trough can be opened and the projectile can be recovered from the filling substance.

### BACKGROUND OF THE INVENTION

I. Field of the Invention.

The present invention relates generally to the field of ballistics, and more particularly to a method and apparatus for trapping bullets for ballistics testing. II. Description of the Related Art.

In many areas of law enforcement, ballistics and forensics, it is often necessary to use projectile research apparatuses such as tanks of water and tanks of ballistics gelatin into which projectiles are fired for research. The goal is to recover the projectile in as near perfect condition to carry out the studies. However, often times the projectile is damaged from the testing itself rendering the tests with inaccuracies. One problem is that the testing medium, for example, the water or the ballistics gelatin, is nearly incompressible. Therefore, when the projectile is shot into the medium, although the medium provides a path for the projectile, the projectile can be damaged from the medium due to the incompressibility. Therefore, markings left on the projectile from the barrel of the gun from which the projectile was shot are also deformed, making it difficult to analyze the projectile.

### SUMMARY OF THE INVENTION

In accordance with the present invention and the contemplated problems which have and continue to exist in this field, the invention features a method and apparatus for recovering a projectile with minimal damage to the projectile.

In general, in one aspect, the invention features a projectile recovery apparatus including an elongated trough having a first end, a second end, a longitudinal axis and a substantially hollow interior and a filling material positioned in the entire interior of the trough and oriented about the longitudinal axis, wherein one of the first and second ends is open, exposing the interior filled with the material, and the other end is closed.

In an implementation, the apparatus of claim 1 includes a gun mount connected to the trough at the open end.

In another implementation, the closed end can be removed to expose the interior of the trough.

In another implementation the filling material is a foam substance such as polyurethane or a fibrous material such as cotton.

In another implementation, the apparatus includes a series of openable hatches that can expose the filling material at various locations along the longitudinal axis.

In another aspect, the invention features a projectile recovery apparatus, including an elongated trough having a first end, a second end, a longitudinal axis and a substantially hollow interior, at least one fibrous layer and at least one foam layer, wherein the fibrous layer and the foam layer are configured along the longitudinal axis, and filling the interior, wherein one of the first and second ends in open, exposing the interior.

In an implementation, the apparatus also includes a gun mount connected to the trough at the open end.

In another implementation, the closed can be removed to expose the interior of the trough.

In another implementation, the apparatus includes a series of openable hatches that can expose the filling material at various locations along the longitudinal axis.

In another implementation, the apparatus includes at least one additional foam layer and at least one additional fibrous layer, wherein the foam layers and fibrous layers are alternately configured along the longitudinal axis.

In another implementation, the foam layers and the fibrous layers are substantially perpendicular to the longitudinal axis and substantially parallel with respect to each other.

In still another implementation, the foam layers and the fibrous layers are angled with respect to the longitudinal axis and substantially parallel with respect to each other.

In an implementation, the foam substance is polyurethane and the fibrous substance is cotton.

In another aspect, the invention features a method of recovering a projectile, including providing a projectile recovery system, having an elongated trough having a first end, a second end, a longitudinal axis and a substantially hollow interior, and a filling material positioned in the entire interior of the trough and oriented about the longitudinal axis, wherein one of the first and second ends is open, exposing the interior filled with the material, and the other end is closed, shooting a projectile into the projectile recovery system substantially parallel to the longitudinal axis, wherein the projectile is aimed at the filling material searching through the filling material of the projectile recovery system for the projectile and recovering the projectile from the projectile recovery system.

In an implementation, the filling material is a foam substance, a fibrous substance or alternating layers of fibrous material and foam material.

One advantage of the apparatus is that a projectile to be studied can be shot into the projectile-capturing medium of the system and can be recovered with minimal to no damage to the projectile for ballistics and forensics research.

Another advantage is that the projectile-capturing medium minimally interferes with the projectile itself.

Another advantage is that as a result of the non-interference of the projectile capturing medium, the projectile includes markings representative of being shot from a unique barrel.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates a perspective view of an embodiment of a projectile recovery apparatus;

FIG. 2 illustrates a top view of an embodiment of a projectile recovery apparatus;

FIG. 3 illustrates a side view of an embodiment of a projectile recovery apparatus;

FIGS. 4A-4F illustrate a view of a projectile as it passes through an embodiment of a projectile recovery apparatus; and

FIG. 5 illustrates a flow chart of an implementation of a method 500 of projectile recovery.

### DETAILED DESCRIPTION OF THE INVENTION

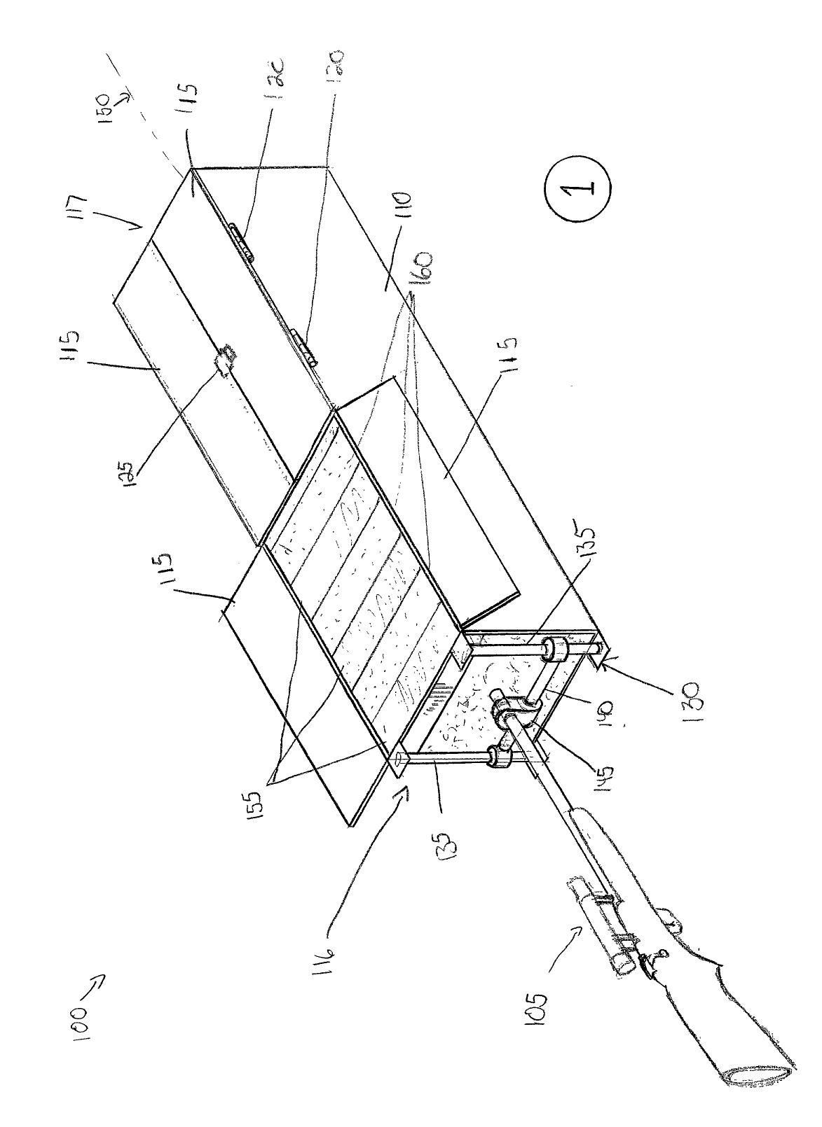

Referring to the drawings wherein like reference numerals designate corresponding parts throughout the several figures, reference is made first to a projectile recovery apparatus wherein FIG. 1 illustrates a perspective view of an embodiment of a projectile recovery apparatus 100 having a gun 105 connected to the apparatus 100. The apparatus 100 typically includes an elongated trough 110. The cross section of the trough can be any variety of shapes. FIG. 1 illustrates the trough 110 having a square cross section. The trough can be any length. Typically, as described in more detail below, it is useful to have the length of the trough be on the order of eight feet. It is understood that any other length can be used. Furthermore, the ends of the trough 110 can be adapted to receive the ends of additional troughs so that a longer overall projectile recovery apparatus can be created by attaching additional troughs.

The trough 110 includes a series of hatches 115 to expose the interior of the trough 110. The hatches 115 are connected to the trough by a mechanism such as a hinge 120. The hatches 115 can be securely closed by lock 125. The hatches generally make up the entire top surface of the trough 110. The tough has a gun receiving end 116 that typically is open exposing the interior of the trough 110. The opposite end 117 is typically a closed end. In an embodiment, the closed end can be adapted to be opened so that an additional trough can be attached to the trough 110.

The trough 110 is constructed of a sturdy material that can prevent a projectile from exiting a surface of the trough 110. In an embodiment, the trough is constructed entirely of a metallic substance.

The trough 110 also includes a gun mount 130. The gun mount 130 is used to support the gun 105 to provide a predictable trajectory of a bullet by preventing the gun from uncontrollably kicking back. The gun mount 130 can have a variety of forms. As shown in FIG. 1 the gun mount 130 includes two vertical support bars 135 and a vertical adjustment cross bar 140. The vertical adjustment bar 140 can be set and secured along the vertical support bars 135. A horizontal adjustment 145 is used to support the barrel of the gun 105 as well as to set and secure the gun horizontally. The horizontal adjustment can also be pivoted about the cross bar 140 providing an angle to the trajectory of the bullet with respect to a longitudinal axis 150 of the trough 110. In general, the user of the projectile recovery apparatus 100 does not adjust the angle of trajectory as described below with respect to operation of the apparatus 100.

The apparatus 100 also includes several alternating layers of fibrous material 155 and foamy material 160. The alternating layers perform as a projectile-capturing medium. Typically, the first layer in the trough 110 is a fibrous layer 155 followed by the foamy material 160 and so forth. The layers are generally perpendicular to the longitudinal axis 150 of the trough 110. The fibrous material 155 can be used through the entire length of the trough 110. The foamy material 160 can also be used throughout the entire length of the trough. However, the alternating layers of the fibrous material 155 and the foamy material 160 have been determined to be an efficient configuration for projectile recovery with minimal to no damage to the projectile.

During operation of the apparatus 100 a projectile generally travels in a trajectory that is generally parallel to the longitudinal axis 150 of the apparatus 100, and perpendicular to the layers 155, 160.

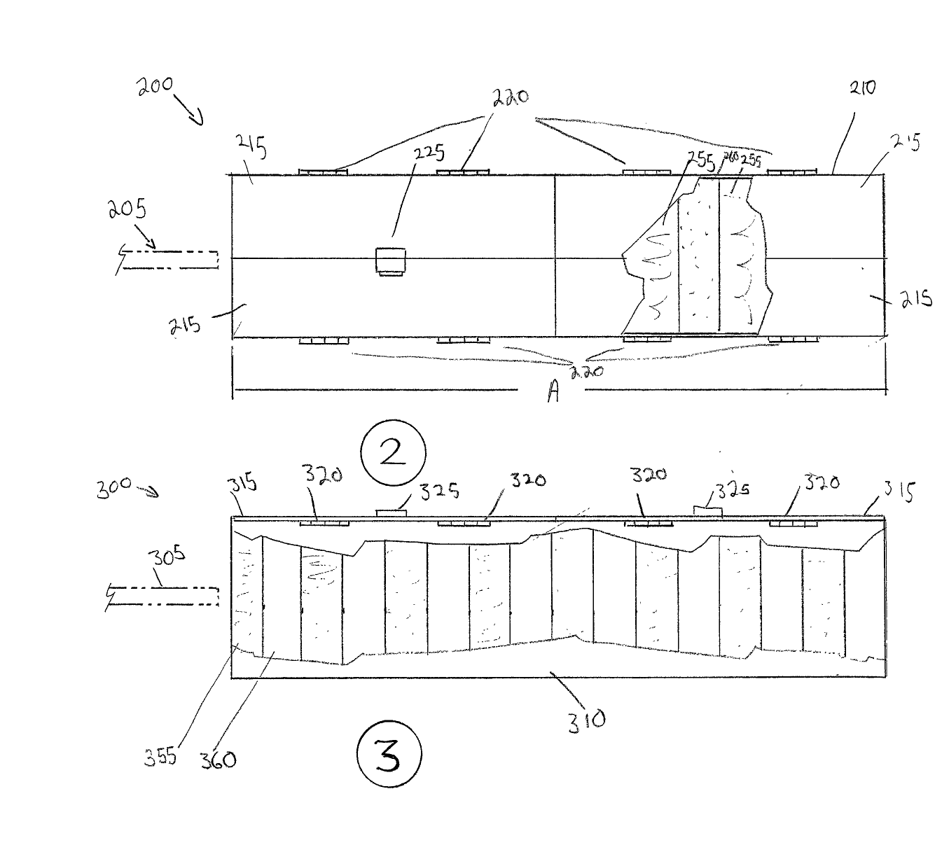

FIG. 2 illustrates a top view of an embodiment of a projectile recovery apparatus 200. A gun barrel 205 is shown aimed into the interior of the trough 210. The hatches 215 are shown in the closed position and securely fastened by lock 225. Each of the hatches 215 can be opened by having hinges 220. A broken view on two of the hatches 215 shows the alternating fibrous material 255 and foamy material 260 through which a projectile can travel in a substantially perpendicular trajectory with respect to the layers 255, 260. The trough is shown to be length A.

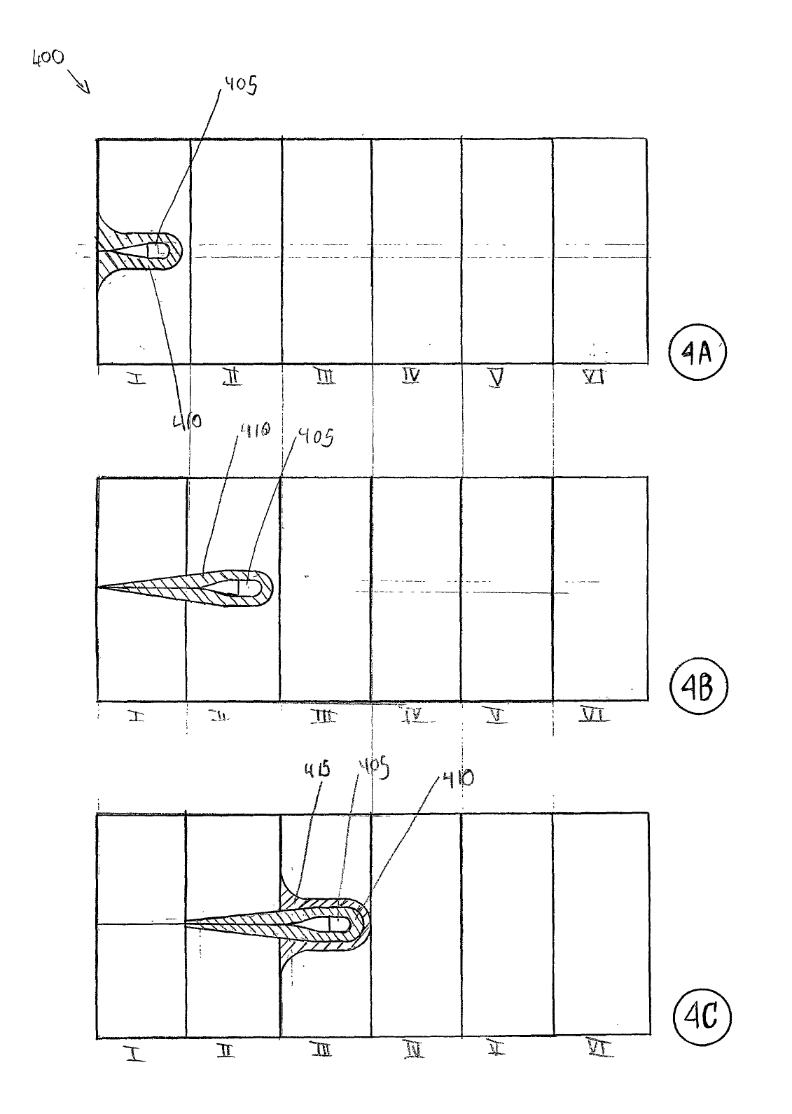

FIG. 3 illustrates a side view of an embodiment of a projectile recovery apparatus 300. A gun barrel 305 is shown aimed into the interior of the trough 310. The hatches 315 are shown in the closed position and securely fastened by lock 325. Each of the hatches 315 can be opened by having hinges 320. A broken view of the side of the trough 310 shows the alternating layers of fibrous material 355 and foamy material 360 through which a projectile can travel in a substantially perpendicular trajectory with respect to the layers 355, 360.

As described above, the materials used for the alternating layers in the projectile recovery apparatus have been described as fibrous and foamy. In one embodiment, cotton can be used for the fibrous layer. In various experiments, it has been determined that for the fibrous material, cotton can be used for efficient projectile recovery. The cotton can be in the form of loose fluffed cotton, cotton balls and cotton batting. It has been experimentally determined that using the different types of cotton does not result in any noticeable change in recovered projectiles.

A variety of other fibrous materials can be used for the fibrous layers so long as the fibrous layer does not interfere with the projectile. Some fibrous materials can stick to the projectile when the projectile is hot. For example, although synthetic cotton can be used in an embodiment, the synthetic cotton doesn't offer as great resistance as natural cotton, taking too long for the projectile to stop. In addition, the fibers do not tend to gather as well on the projectile (as described below with respect to operation of the apparatus). Finally, the heat from the fired projectile causes the synthetic cotton to fuse to the projectile, making it difficult to remove from the projectile, thereby interfering with ballistics testing.

In one embodiment, the foamy layers can be expanded polyurethane foam, which is typically a make-up of calcium carbonate and malomine. In various experiments, it has been determined that soft, medium or high density foam can be used for the foamy layers for efficient projectile recovery. It is understood that various other foamy materials can be used for the foamy layers. The expanded polyurethane foam has been experimentally determined to stop the projectile quickly with minimal to no damage to the projectile. The expanded polyurethane foam has the following typical characteristics:

Light: Density of 1 lb. per cubic foot with a compression of 20 to 25.

Medium: Density of 2 lb. per cubic foot, with a compression of 28 to 33.

Heavy: Density of 3 lb. per cubic foot, with a compression of 40 to 45.

Typically the compression of foam is determined by placing ga 5 inch steel weight of approximately 20 lbs on foam using an arbitrary scale to measure.

It has been experimentally determined that medium density foam provides the optimum results. Soft foam does not stop the projectile as quickly as desired causing longer stopping distances. Heavy foam tends to cause “pitting” on the projectile as described further below. Other types of foam are also contemplated. Such foamy material may also include rubber or latex foam.

### Projectile Recovery Method

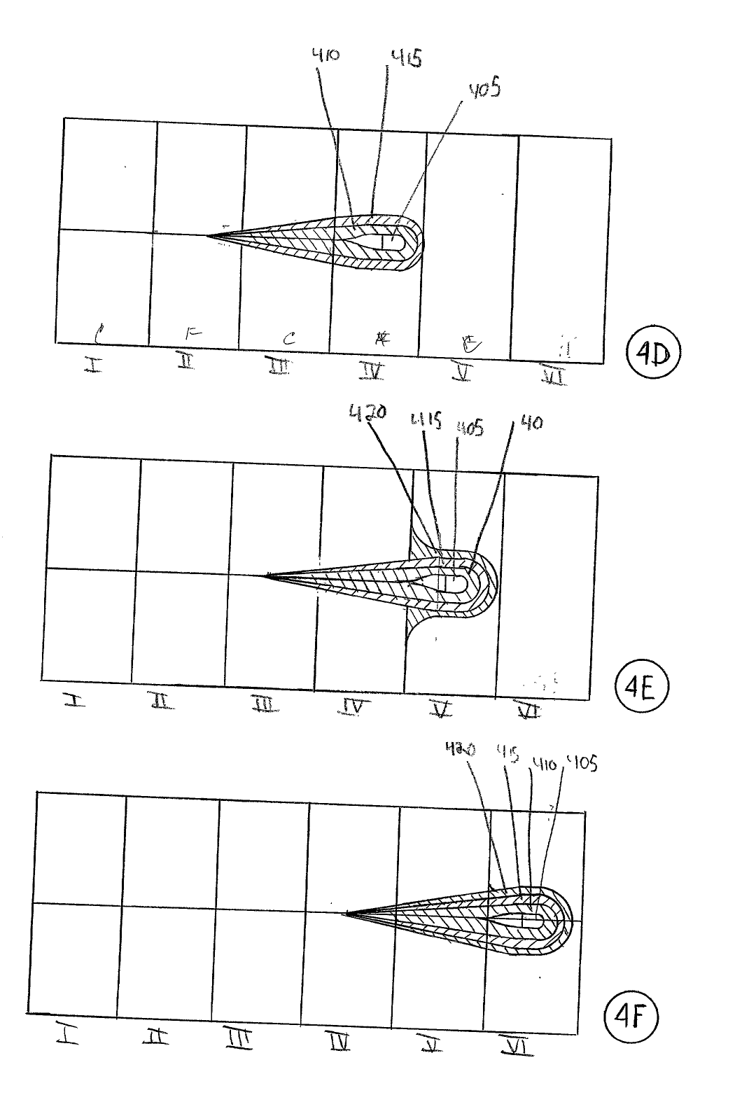

The projectile recovery apparatus described above with respect to FIGS. 1-3 can be used to fire a projectile into the interior of the trough through the alternating layers. The apparatus can typically be used for ballistics testing, leaving the projectile in a condition with minimal to no damage from the alternating layers. The travel of the projectile through the alternating layers is now described with respect to FIGS. 4A-4F which illustrate a projectile at various points in a projectile recovery apparatus.

FIG. 4A illustrates a side view of a projectile recovery apparatus 400 at a point in which a projectile 405 is initially shot into the apparatus 400. The projectile 405 first enters the fibrous layer I. As the projectile moves through the layer I, the projectile 405 quickly gathers fibers from the layer around the projectile 405. As the fiber gathers it creates a first fiber covering 410 around the projectile 405. It has been determined that minimal to no damage is caused to the projectile from the fibrous layer I. By passing through the layer I the projectile also loses some of its kinetic energy, momentum and velocity due to friction from the surrounding layer I and increasing fiber covering 410.

FIG. 4B illustrates a side view of the projectile apparatus of FIG. 4A at a point in which a projectile is traveling through the apparatus. After leaving layer I, the projectile then enters layer II, which is typically a foamy layer. The projectile also travels with the fiber covering 410 as it travels through the foamy layer II. Friction between the fibers covering 410 and the foam layer II removes more kinetic energy momentum and velocity from the projectile 405. The fiber cover 410 also provides protection for the projectile 405 as it travels through the foamy layer II that is relatively rougher than the fibrous layer I.

FIG. 4C illustrates a side view of the projectile apparatus of FIGS. 4A and 4B at a point in which a projectile is traveling through the apparatus 400. After leaving layer II the projectile then enters layer II that is typically a fibrous layer. The projectile still includes the fiber covering 410. As the projectile 405 travels through the layer III along with the cover410, the cover410 begins to become covered with another fiber layer 415. The friction of the cover 410 with the surrounding layer and the increasing cover 415 further decreases the kinetic energy, momentum and velocity of the projectile 405.

FIG. 4D illustrates a side view of the projectile apparatus of FIGS. 4A-4C at a point in which a projectile is traveling through the apparatus 400. After leaving layer III, the projectile then enters layer IV, which is typically a foamy layer. The projectile 405 also travels with the fiber coverings 410, 415 as it travels through the foamy layer IV. Friction between the fiber covering 415 and the foam layer IV removes more kinetic energy momentum and velocity from the projectile 405. The covers 410, 415 also provide protection for the projectile 405 from the rough foam layer IV.

FIG. 4E illustrates a side view of the projectile apparatus of FIGS. 4A and 4D at a point in which a projectile is traveling through the apparatus 400. After leaving layer IV the projectile then enters layer V that is typically a fibrous layer. The projectile still includes the fiber covers 410, 415. As the projectile 405 travels through the layer V along with the covers 410, 415, the cover 415 begins to become covered with another fiber layer 420. The friction of the cover 415 with the surrounding layer V and the increasing cover 420 further decreases the kinetic energy, momentum and velocity of the projectile 405.

FIG. 4F illustrates a side view of the projectile apparatus of FIGS. 4A-4E at a point in which a projectile is traveling through the apparatus 400. After leaving layer V, the projectile then enters layer VI, which is typically a foamy layer. The projectile 405 also travels with the fiber coverings 410, 415, 420 as it travels through the foamy layer VI. Friction between the fiber covering 420 and the foam layer VI removes more kinetic energy momentum and velocity from the projectile 405. The covers 410, 415, 420 also provide protection for the projectile 405 from the rough foam layer VI. In an implementation, depending on the muzzle velocity of the projectile, the projectile 405 finally loses all of its velocity and ceases moving in layer VI. When the projectile 405 comes to a stop, the fiber covers 410, 415, 420 typically leave a tail portion as shown in layers IV, V.

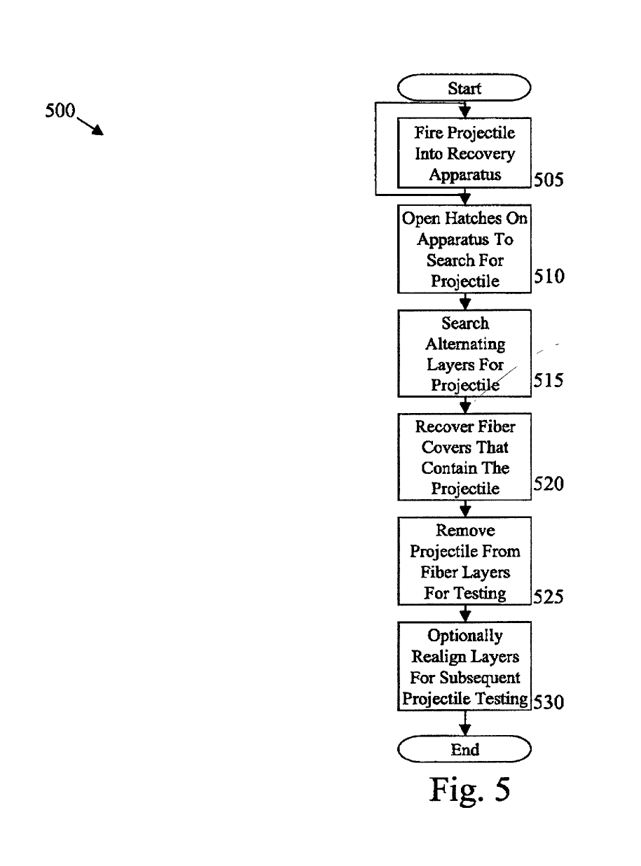

FIG. 5 illustrates a flow chart of an implementation of a method 500 of projectile recovery using the apparatus described above. The user of the apparatus chooses a gun to be tested. The gun is mounted on the apparatus on the gun mount described above. The projectile is then fired 505 into the recovery apparatus. This process of firing a projectile apparatus can be repeated as many times as desired. Typically, the user repositions the gun so that the subsequent projectile does not travel the same trajectory as the previous projectile. It is desirable not to fire too many projectiles into the apparatus without changing the layers. Too many projectiles fired into the layers typically causes the foam to weaken which results in greater stopping distances. New foam offers more resistance to the projectile and fiber covers resulting in substantially short stopping times and shorter stopping distances.

Once the desired number of projectiles are fired into the apparatus, the user opens 510 the hinges of the apparatus to search for the projectile. Typically, the user searches 515 the alternating layers and separates the layers to search for the fiber trail caused by the accumulation of fiber covers as discussed above. The user typically discovers an accumulated ball of fiber. The user recovers 520 the fiber covers containing the projectile. The user then removes 525 the projectile from the fibers layers for subsequent testing.

The user can then optionally realign 530 the layers to prepare the apparatus to receive subsequent projectiles. The user may have to replace the foam and cotton as described above.

When the projectile is recovered it is typically in virtually the same condition as it was before it was fired. The following tables illustrate empirical data on several different types of projectiles fired into the apparatus and the corresponding layer characteristics:

TABLE 1

| Cotton/Foam | | | |
|---|---|---|---|
| Layering | Caliber | Stopping Distance | Projectile Condition |
| 1″ 1″ | 7.62 × 39 | 11′ 5″ | Perfect |
| 1″ 1″ | 45 ACP | 2′ 8″ | Perfect |
| 2″ 2″ | 7.62 × 39 | 12′ 0″ | Some Burning |
| 2″ 2″ | 45 ACP | 3′ 6″ | Perfect |
| 3″ 3″ | 7.62 × 39 | 13′ 3″ | Some Burning |
| 3″ 3″ | 45 ACP | 3′ 9″ | Perfect |
| 4″ 4″ | 7.62 × 39 | 11′ 11″ | Perfect |
| 4″ 4″ | 45 ACP | 4′ 6″ | Perfect |
| 4″ 4″ | 40 | 4′ 6″ | Perfect |
| 5″ 5″ | 7.62 × 39 | 10′ 6″ | Perfect |
| 5″ 5″ | 45 ACP | 2′ 10″ | Perfect |
| 6″ 6″ | 7.62 × 39 | 11′ 0″ | Perfect |
| 6″ 6″ | 45 ACP | 3′ 3″ | Perfect |
| 7″ 7″ | 7.62 × 39 | 10′ 10″ | Perfect |
| 7″ 7″ | 45 ACP | 3′ 0″ | Perfect |
| 8″ 8″ | 7.62 × 39 | 10′ 9″ | Perfect |
| 8″ 8″ | 45 ACP | 2′ 10″ | Perfect |
| 8″ 8″ | 40 | 4′ 0″ | Perfect |
| 9″ 9″ | 7.62 × 39 | 12′ 6″ | Perfect |
| 9″ 9″ | 45 ACP | 4′ 0″ | Perfect |
| 10″ 10″ | 7.62 × 39 | 12′ 5″ | Some Burning |
| 10″ 10″ | 45 ACP | 2′ 2″ | Perfect |
| 11″ 11″ | 7.62 × 39 | 10′ 5″ | Some Burning |
| 11″ 11″ | 45 ACP | 2′ 2″ | Perfect |
| 12″ 12″ | 7.62 × 39 | 10′ 5″ | Some Burning |
| 12″ 12″ | 45 ACP | 3′ 5″ | Perfect |
| 12″ 12″ | 40 | 3′ 9″ | Perfect |

TABLE 2

| | | Muzzle | | |
|---|---|---|---|---|
| | | Velocity | Muzzle Energy | Stopping |
| Caliber | Weight | (FPS) | (Foot Pounds) | Distance |
| 22 Cal REM HP | 36 Grains | 1410 | 165 | 3′ 10″ |
| 7 mm REM MAG | 150 Grains | 310 | 3221 | 17′ 7″ |
| 223 SS109 | 62 Grains | 3025 | 1260 | 11′ 10″ |
| (AP) | | | | |
| 40 S&W | 180 Grains | 1150 | 499 | 4′ 6″ |
| 30 −30 WIN | 150 Grains | 2390 | 1900 | 10′ 4″ |
| 45 CAL HYDRA | 230 Grains | 850 | 370 | 4′ 0″ |
| SHOCK | | | | |
| 38 Special | 158 Grains | 760 | 200 | 3′ 7″ |
| 12 Gauge Slug | 1 Ounce | 1525 | 2260 | 7′ 0″ |
| 8 mm (AP) | 154 Grains | 2880 | 2837 | 13′ 7″ |
| 7.62 × 39 | 123 Grains | 2365 | 1552 | 11′ 11″ |
| 9 mm Starfire | 124 Grains | 1175 | 364 | 3′ 4″ |

The data in Table 2 are results from tests in the projectile recovery apparatus using alternating layers of cotton fiber of 4″ and medium density foam layers of 4″.

A number of embodiments have been described. Nevertheless, it will be understood that various modifications may be made without departing from the spirit and scope of the invention. Several examples are now illustrated.

As mentioned above all foam or all fiber layers can be used in the apparatus. In this embodiment, the bullet tends to be more difficult to locate. Using all foam does stop the projectile quickly but tends to cause pitting on the projectile. Using all fiber layers also stops the projectile quicker but does not always leave powder residue. In addition the projectile is difficult to find in all fiber layers. Finally the nose of the projectile tends to deform with all fiber layers.

The following data are results for various tests of projectiles using all fiber or all foam layers:

TABLE 3

| Caliber | Material | Stopping Distance | Projectile Condition |
|---|---|---|---|
| 7.62 × 39 | All Foam | 15′ 7″ | Poor (Pitted) |
| | All Fiber | 7′ 8″ | Poor (Burnt) |
| 45 ACP Cast Lead | All Foam | 1′ 6″ | Good |
| | All Fiber | 1′ 10″ | Good |
| 45 ACP 230 gr HP | All Foam | 7′ 2″ | Fair |
| | | | (Nose Deformed) |
| | All Fiber | 2′ 2″ | Good |
| 7 mm REM MAG. | All Foam | 20′ 0″ | Good |
| | All Fiber | 13′ 7″ | Fair |
| 8 mm | All Foam | 17′ 4″ | Good |
| | All Fiber | 10′ 8″ | Good |
| 40 S & W | All Foam | 11′ 5″ | Fair (Slight Pitting) |
| | All Fiber | 1′ 11″ | Good |

The embodiments described above have typically included projectiles in the of bullets. In another embodiment, the projectile recovery apparatus can be to test arrows BBs and other types of projectiles. It is understood that there limit to the types of projectiles that can be used in the apparatus.

Therefore, the foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A projectile recovery apparatus, comprising:
an elongated trough having a first end, a second end, a longitudinal axis and a substantially hollow interior,
a filling material positioned in the entire interior of the trough and oriented about the longitudinal axis, and
wherein one of the first and second ends is open, exposing the interior filled with the material, and the other end is closed.

2. The apparatus as claimed in claim 1 further comprising a gun mount connected to the trough at the open end.

3. The apparatus as claimed in claim 1 wherein the closed end be removed to expose the interior of the trough.

4. The apparatus as claimed in claim 1 wherein the filling material is a foam substance.

5. The apparatus as claimed in claim 4 wherein the foam substance is polyurethane.

6. The apparatus as claimed in claim 1 wherein the filling material is a fibrous substance.

7. The apparatus as claimed in claim 6 wherein the fibrous substance is cotton.

8. The apparatus as claimed in claim 1 further comprising a series of openable hatches that can expose the filling material at various locations along the longitudinal axis.

9. A projectile recovery apparatus, comprising:
an elongated trough having a first end, a second end, a longitudinal axis and a substantially hollow interior,
at least one fibrous layer,
at least one foam layer, wherein the fibrous layer and the foam layer are configured along the longitudinal axis, and filling the interior, and
wherein one of the first and second ends is open, exposing the interior.

10. The apparatus as claimed in claim 9 further comprising a gun mount connected to the trough at the open end.

11. The apparatus as claimed in claim 9 wherein the closed end be removed to expose the interior of the trough.

12. The apparatus as claimed in claim 9 further comprising a series of openable hatches that can expose the filling material at various locations along the longitudinal axis.

13. The apparatus as claimed in claim 9 further comprising:
at least one additional foam layer,
at least one additional fibrous layer, and
wherein the foam layers and fibrous layers are alternately configured along the longitudinal axis.

14. The apparatus as claimed in claim 13, wherein the foam layers and the fibrous layers are substantially perpendicular to the longitudinal axis and substantially parallel with respect to each other.

15. The apparatus as claimed in claim 13, wherein the foam layers and the fibrous layers are angled with respect to the longitudinal axis and substantially parallel with respect to each other.

16. The apparatus as claimed in claim 9 wherein the foam substance is polyurethane.

17. The apparatus as claimed in claim 9 wherein the fibrous substance is cotton.

18. A method of recovering a projectile, comprising:
providing a projectile recovery system, including:
an elongated trough having a first end, a second end, a longitudinal axis and a substantially hollow interior; and
a filling material positioned in the entire interior of the trough and oriented about the longitudinal axis,
wherein one of the first and second ends is open, exposing the interior filled with the material, and the other end is closed,
shooting a projectile into the projectile recovery system substantially parallel to the longitudinal axis, wherein the projectile is aimed at the filling material,
searching through the filling material of the projectile recovery system for the projectile, and
recovering the projectile from the projectile recovery system.

19. The method as claimed in claim 18 wherein the filling material is a foam substance.

20. The method as claimed in claim 18 wherein the filling material is a fibrous substance.

21. The method as claimed in claim 20 wherein the filling material comprises alternating layers of fibrous material and foam material.
